(19) United States
(12) Patent Application Publication
(10) Pub. No.: US 2002/0175829 A1
(43) Pub. Date: Nov. 28, 2002

(54) System and method for warning of an upcoming precautionary zone

(76) Inventors: Oqullia M. Dunagin, Garland, TX (US); Melvin J. Waddleton, Garland, TX (US); Brenda S. Yates, Garland, TX (US); Carnelius E. Yates, Garland, TX (US); Leslie D. Major, Mesquite, TX (US)

Correspondence Address: Michael L. Diaz, Michael L. Diaz, P.C., Suite 200, 555 Republic Drive, Plano, TX, 75074, US

(21) Appl. No.: 09/866,315

(22) Filed: May 25, 2001

(51) Int. Cl. G08G 1/00

(52) U.S. Cl. 340/905; 340/531; 340/908; 340/908.1; 340/573.4

(57) ABSTRACT

A method and system for warning a driver of a vehicle of an upcoming precautionary zone. The system includes a light emitter which emits an infrared coded light signal associated with a precautionary zone. A receiver mounted within the vehicle detects the infrared coded light signal when approaching the precautionary zone. The receiver decodes the light signal and associates the light signal with a specific category of a precautionary zone. The receiver informs an alert system located within the vehicle of the proximity and category of precautionary zone. The alert system provides an indication to the driver of the proximity and category of the precautionary zone. The indication may include a visual, audio, or other electrical indicator providing a warning to the driver.

### BACKGROUND OF THE INVENTION

1. Technical Field of the Invention

This invention relates to warning systems and, more particularly, to a system and method for warning a driver of a vehicle of an upcoming precautionary zone requiring increased driver vigilance.

2. Description of Related Art

Today's automobile driver encounters may hazards and precautionary zones requiring increased attention by the driver. For example, during the transiting of a school zone, a driver is legally required to slow to a specified speed limit. Additionally, when the driver approaches a stopped school bus, the driver is required to stop his automobile and wait for the bus to continue down the road. Legally, the driver cannot pass the stopped bus. All of these laws were passed in order to provide increased safety for children. Children are known to run out into the street, which provides hazards to both the children and automobile drivers. To combat the inattentiveness of children, the driver must be at his highest level of alertness. Unfortunately, drivers are confronted with a myriad of distractions. These distractions range from adjusting controls located within the automobile, speaking on a mobile phone, or even seeing to the needs of children riding within the automobile. All of these distractions divert the attention of the driver away from outside warning signs warning of upcoming precautionary zones.

A primary example where upcoming precautionary zones may be encountered without warning are school zones. It is not uncommon to see a flashing sign indicating the presence of a school zone. However, if the driver does not notice the sign, the warning can easily be missed. In another example, it is difficult for drivers to notice moving vehicles such as emergency vehicles or school buses. Many times, school buses are located around a corner from an oncoming vehicle which may hide the stopped bus from view. A system and method are needed which provides an inexpensive, simple warning system for the driver of a vehicle and gives a noticeable warning indication to the driver which cannot be missed.

Although there are no known prior art teachings of a solution to the aforementioned deficiency and shortcoming such as that disclosed herein, prior art references that discuss subject matter that bears some relation to matters discussed herein are U.S. Pat. No. 4,100,529 to Evans (Evans), U.S. Pat. No. 4,196,412 to Sluis et al. (Sluis), U.S. Pat. No. 4,942,395 to Ferrari et al. (Ferrari), and U.S. Pat. No. 5,187,476 to Hamer (Hamer).

Evans discloses a system for warning vehicle drivers of the proximity of a road hazard. Each road hazard, such as moving emergency vehicles, includes a radio frequency signal transmitter which transmits a signal length coded signal which is unique for each hazard. Receivers are mounted in vehicles which are responsive to the set radio frequency. When an equipped vehicle is within range of the road hazard warning transmitter, a light in the vehicle will flash on and off in synchronism with the signal length coded signal. Additionally, this signal drives a sound generator on and off to provide a coded audio signal. However, Evans does not teach or suggest a simple and inexpensive infrared emitter and receiver to provide warning of the proximity of a potential traffic hazard. Additionally, Evans merely utilizes a radio transmitter and receiver, which is both expensive, prone to electronic interference, and complicated to operate.

Sluis discloses an apparatus for insuring a vehicle operator's attentiveness at potentially dangerous locations along a path of travel. The system includes a signaling device which is located in advance of a potentially dangerous location, in the direction of travel of the vehicle. A vehicle carried signal device responds to the signaling device when within the effective zone of the signaling device. The vehicle includes a warning apparatus, such as an alert or buzzer. The vehicle also includes an operator actuated push button and a speed sensing apparatus. A control device responds to the push button and to the vehicle carried signal responsive device to operate the warning apparatus. The operator evidences his alertness of the potentially dangerous location by actuating the push button prior to reaching the signaling device, the control apparatus sounds the warning apparatus when the signaling device is detected and resets itself. However, if the operator fails to actuate the push button in advance of the detection of the signaling device, then the alarm is energized and will remain energized until the vehicle is brought to a stop, low speed, or the push button is actuated. However, Sluis does not teach or suggest a simple and inexpensive infrared emitter or receiver. Sluis suffers from the disadvantage of utilizing a transmitter in each vehicle, which would be expensive. Additionally, by utilizing a complicated push button system, the system can becomes much too cumbersome for the typical driver to use and provide further distractions to the driver.

Ferrari discloses a three-piece, compact wireless railroad grade crossing motorist warning device having a locomotive mounted transceiver which simultaneously communicates (upon close proximity) with a similar transceiver mounted at a railroad grade crossing, and motor vehicles equipped with sympathetic receivers. Upon signal receipt verification, the grade crossing transceiver emits a coded radio signal to locate motoring public sympathetic receivers. Upon signal reception, an audio/visual alert is presented to the motor vehicle operator, alerting the motor vehicle operator to the locomotive-occupied railroad crossing. However, Ferrari does not teach or suggest a simple infrared warning system. Additionally, Ferrari suffers from the disadvantage of requiring three devices, one mounted on the train, one mounted on the vehicle, and another mounted at the railroad crossing.

Hamer discloses an optical traffic preemption detector which detects pulses of light emitted by an approaching emergency vehicle and provides an output signal which is processed by a phase selector. The phase selector may request a traffic signal controller to preempt a normal traffic signal sequence to give priority to the emergency vehicle. A detector assembly is mounted in proximity to an intersection and can have multiple detector channels. Hamer does not teach or suggest a warning system. Rather, Hamer merely discloses a device to change the signal of a light signal.

Thus, it would be a distinct advantage to have a system and method which provides a noticeable warning indication to a driver of a vehicle of an upcoming area requiring the increasing attention of the driver. The system and method must be simple and inexpensive to provide a pervasive system for broad-based use. It is an object of the present invention to provide such a system and method.

### SUMMARY OF THE INVENTION

In one aspect, the present invention is a system for warning a driver of a vehicle of an upcoming precautionary zone. The system includes a light emitter. The light emitter is associated with the precautionary zone and emits a coded light signal. In addition, the system includes a receiver for detecting the coded light signal from the emitter. The receiver is mounted on the vehicle. An alert system is used for indicating a warning to the driver when the receiver detects the coded light signal from the light emitter. The warning provides a visual, audio, or other electrical signal to the driver alerting the driver of the proximity of the precautionary zone.

In another aspect, the present invention is a method of warning a driver of a vehicle of an upcoming precautionary zone. The method begins by a transmitter emitting a coded light signal. The transmitter is located at or near the precautionary zone. Next, a receiver detects the coded light signal. The receiver is mounted on the vehicle. The receiver then informs an alert system of the receipt of the coded light signal. The alert system provides a warning of the proximity of the precautionary zone to the driver. The warning may be a visual, audio, or other electrical signal.

In still another embodiment, the present invention is a system for warning a driver of a vehicle of an excessive speed associated with an upcoming precautionary zone. The system includes a light emitter associated with the precautionary zone. The light emitter emits a coded light signal indicating a speed limit associated with the precautionary zone to the vehicle. A receiver, located on the vehicle, is used for detecting and decoding the coded light signal from the emitter. A microprocessor, also located on the vehicle, receives the decoded light signal from the receiver and compares the speed limit with a speed of the vehicle. The microprocessor sends a signal to an alert system to provide an indication to the driver of the speed of the vehicle and an excess of the speed limit of the precautionary zone by the vehicle.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for warning a driver of an upcoming area requiring increased attentiveness by the driving;

FIG. 2 is a block diagram illustrating the components of the transmitter in the preferred embodiment of the present invention;

FIG. 3 is a block diagram illustrating the components of the receiver in the preferred embodiment of the present invention;

FIGS. 4A-4B are flow charts outlining the steps for warning a driver of a vehicle of an upcoming precautionary zone according to the teachings of the present invention;

FIG. 5 is a simplified block diagram illustrating the components of a warning system for warning a driver when exceeding a specified speed limit;

FIG. 6 is a block diagram illustrating the components of the transmitter and receiving in an alternate embodiment of the present invention; and

FIG. 7 is a block diagram illustrating the components of the receiver in an alternate embodiment of the present invention.

### DETAILED DESCRIPTION OF EMBODIMENTS

The present invention is a system and method for providing a warning of an upcoming precautionary zone requiring the increased attentiveness of a driver of a vehicle approaching the precautionary zone.

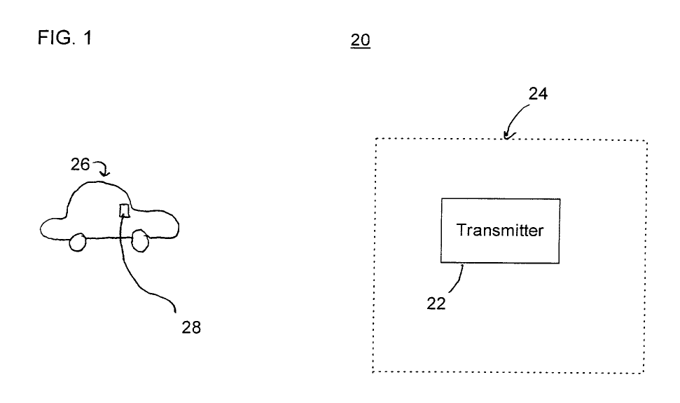

FIG. 1 is a simplified block diagram illustrating the components of a system 20 for warning a driver of an upcoming area requiring increased attentiveness by the driver. The system includes a transmitter 22 located at or near a precautionary zone 24 and a vehicle 26 having a receiver 28.

The transmitter 22 is preferably a device which emits infrared light in a specific direction. Preferably, the emitted beam utilizes a horn type pattern that will cover all lanes of approaching traffic. The infrared light transmitter is well known in the art of light emitting devices. In the preferred embodiment of the present invention, the wavelength of the infrared light is eye safe. Additionally, the infrared light source requires a relatively small power source. However, in alternate embodiments of the present invention, the device may emit any type of light or any other type of electromagnetic beam.

The transmitter 22 is located near or within the precautionary zone 24. The transmitter may be located beside, above, or on a road running toward the precautionary zone. Alternatively, the transmitter may be mounted on a raised platform (not shown).

The receiver 28 is located on the vehicle 26 in such a fashion to detect any light source emanating from the transmitter 22. The receiver is a conventional light detecting receiver. Examples of existing devices which use a light detecting receiver are police laser guns. Preferably, the receiver is located on a front portion of the vehicle such as the vehicle's grill or the vehicle's dashboard. Either of these areas provide a clear frontal area allowing detection of light sources located in front of the vehicle.

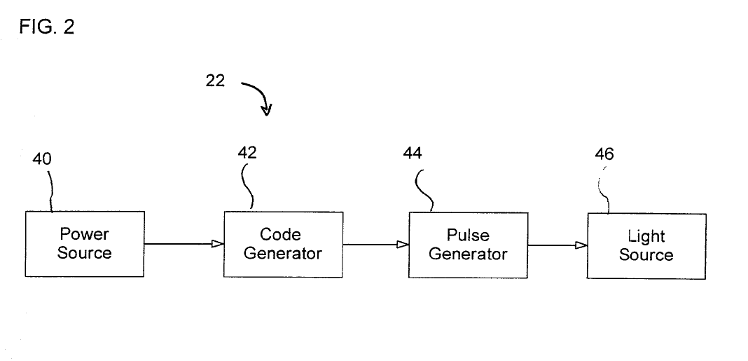

FIG. 2 is a block diagram illustrating the components of the transmitter 22 in the preferred embodiment of the present invention. The transmitter includes a power source 40, a code generator 42, a pulse generator 44, and a light emitting source 46. The power source may be any device providing electrical power to the transmitter. For example, the transmitter may be powered by AC power provided via a standard electrical cord. The transmitter may be powered by a DC power source, such as a battery. In still an alternate embodiment of the present invention, the power source may include power generated by solar panels. Additionally, the power source may be a combination of conventional power sources.

In the preferred embodiment of the present invention, the code generator generates a code associated with a specific category of the precautionary zone. For example, the code generator may generate a code associated with a school zone. Where the transmitter is located in another zone, such as a hospital zone, the code generator would generate the specified code for the hospital zone. In still another embodiment, the code generator may generate a code associated with a particular speed allowable by vehicles transmitting the road where the transmitter is located.

The code generator provides the code to the pulse generator 44. The code is used by the pulse generator to create a pulsed light beam associated with the code. The pulse generator, in conjunction with the light emitting source 46, generates the coded light beam outwardly from the transmitter.

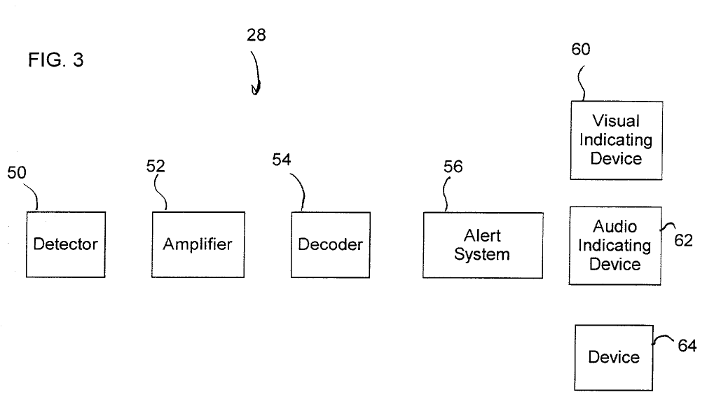

FIG. 3 is a block diagram illustrating the components of the receiver 28 in the preferred embodiment of the present invention. The receiver includes a detector 50 for detecting the light source emanating from the transmitter 22. In the preferred embodiment of the present invention, the detector includes a filter to prevent interference from stray light sources, such as sunlight or approaching headlights of oncoming vehicles. As discussed above, the preferred embodiment of the present invention utilizes an infrared transmitter, as well as an infrared detector.

The detected light signal received by the detector 50 is amplified by an amplifier 52. The amplified detected light signal is then fed to a decoder 54. The decoder interprets the pulse of the detected light and correlates the pulse with the specified code. The decoder then interprets the specified code with its associated precautionary zone category. The decoder feeds a signal associated with the interpreted precautionary zone category to an alert system 56.

The alert system 56 may include one or more warning indicators to drivers of vehicles to which the receiver 28 is installed. The alert system may provide a signal to a visual indicating device 60, such as a flashing light prominently displayed to the driver of the vehicle. In addition, the alert system may include an audio indicating device 62, providing an aural warning to the driver. The aural warning may be a warning sound (e.g., buzz or chime) or series of specified sounds (e.g., different numbers or tone), or may include a verbal warning provided through a voice synthesizing device located within the alert system. In addition, the alert system may provide an electrical signal to some other type of device 64, such as a head up display (HUD). The HUD may provide symbology to indicate to the driver utilizing the HUD on a front windshield of the vehicle the proximity and type of upcoming precautionary zone. In another embodiment of the present invention, the device 64 may be a safety device which automatically brakes the vehicle or governs the speed of the vehicle when receiving the signal from the alerting system. The alert system may use one, a plurality or all of the indicators to provide a warning to the driver.

With reference to FIGS. 1-3, the system 20 will now be explained. The driver of the vehicle 26 drives along a road, unaware of the upcoming precautionary zone 24. For this example, the precautionary zone is a school area requiring a reduced speed. Without the system 20, the driver merely receives a sign having a flashing yellow light to warn of the upcoming school zone. Since the warning is located outside the vehicle, it is extremely easy for the driver to miss the warning. With the utilization of the system 20, the driver receives ample warning of the upcoming school zone within the interior of the vehicle, where the warning indicator is less likely to be missed.

The transmitter 22 constantly transmits a coded infrared light signal outwardly from the light emitting source 46. The transmitter is located just outside the precautionary zone and emits the light away from the precautionary zone. The light emitted from the transmitter is coded to indicate that the precautionary zone is a school zone. The detector 50 located on a front portion of the vehicle 26 detects the coded light signal. This detected light signal is amplified by the amplifier 52 and decoded by the decoder 54. The decoder interprets that the light is associated with a school zone. A signal is sent to the alert system 56 indicating the proximity of the upcoming school zone. The alert system then sends a signal to one or more indicating devices. The indicating devices may provide a visual or aural indication of the upcoming school zone to the driver. Additionally, the alert system may send a signal to the device 64 for use with an auxiliary safety device. The driver receives the warning indication and acts appropriately (e.g., increased attentiveness for children and reduced speed).

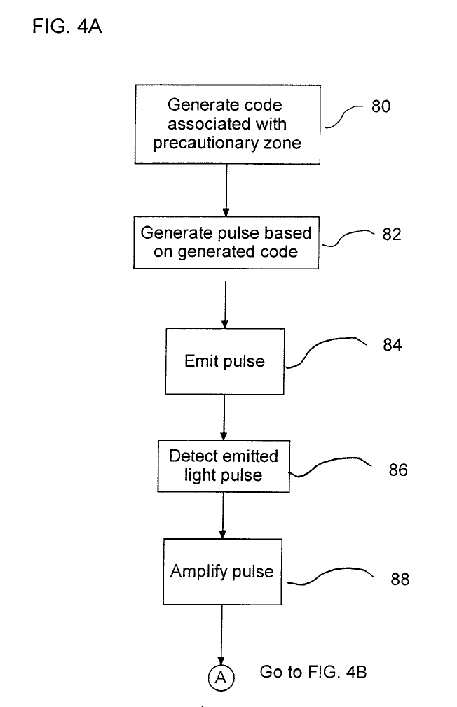

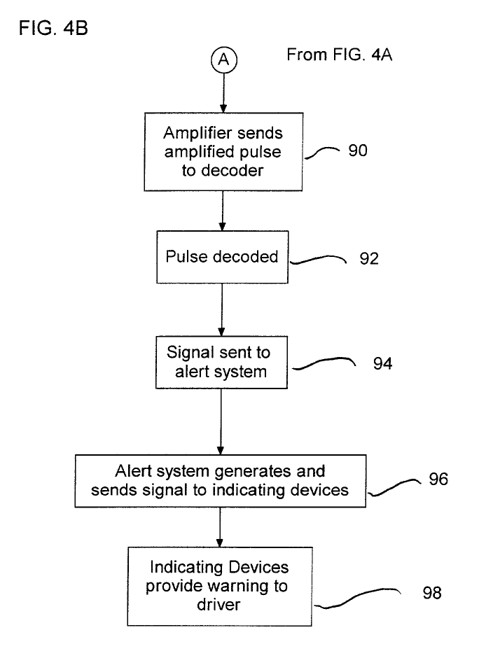

FIGS. 4A-4B are flow charts outlining the steps for warning a driver of a vehicle 26 of an upcoming precautionary zone according to the teachings of the present invention. FIGS. 1, 2, 3, 4A and 4B, the steps of the method will now be explained. The method begins with step 80 where the code generator 42 generates a code associated with the precautionary zone category. For example, if the precautionary zone is associated with a school, the code generator generates a code identifying the precautionary zone as a school zone. If the precautionary zone is a hospital zone, the code generate generates a code identifying the precautionary zone as a hospital zone. Next, in step 82, the pulse generator 44 generates a light pulse which is associated with the generated code from the code generator.

The method continues with step 84 where the generated light pulse is emitted via the light emitting source 46 outwardly, away from the precautionary zone. In the preferred embodiment of the present invention, the emitted light pulse is directed toward a specific direction, such as down a road leading to the precautionary zone. As the vehicle approaches the precautionary zone, the detector 50 mounted on the front of the vehicle 26, detects the emitted light pulse in step 86. In the preferred embodiment of the present invention, the detector includes a filter to eliminate stray light not associated with a transmitter.

Next, in step 88, the detected light pulse is processed and amplified by the amplifier 52. In step 90, the amplifier sends the amplified light pulse to the decoder 54. Then, in step 92, the decoder decodes the light pulse, associating the coded light pulse with a specific category of a precautionary zone. In step 94, the decoder sends a signal to the alert system 56 identifying the category of precautionary zone to the alert system. In step 96, the alert system converts the signal sent from the decoder into a signal to one or more indicating devices, such as the visual indicating device 60 and the audio indicating device 62. Additionally, the alert system may send a signal to another device 64, which may be associated with an auxiliary safety device installed in the vehicle. This auxiliary safety device may automatically slow the vehicle to a slower speed, or even apply brakes as necessary. In step 98, the indicating device provides a visual or audible warning to the driver of the vehicle.

In the preferred embodiment discussed above, the transmitter is stationary and located on or near a stationary precautionary zone. However, in an alternative embodiment of the present invention, the transmitter may be mobile. For example, the transmitter may be attached to a moving vehicle, such as a school bus or an emergency vehicle. If a school bus is stopped during the loading or unloading of children, the transmitter 22 may generate a code warning the driver of the vehicle that the school bus is stopped. If the bus is moving, the transmitter may generate another code warning that the vehicle is approaching the school bus, but that the school bus is not stopped for unloading or loading of children.

The system 20 provides many advantages over existing warning devices. The system 20 provides a warning within the interior of the vehicle, thus providing a more noticeable indication of an upcoming precautionary zone. Additionally, since the light source is mounted at or near the precautionary zone, each vehicle merely requires an inexpensive detector. If the warning system were expensive to implement on each vehicle, the likelihood of most vehicles incorporating the warning system into the vehicle is reduced. Thus, by requiring the transmitter, the most expensive component of the warning system 20, to be located at the precautionary zone, costs are reduced. The system 20 also utilizes a safe infrared light beam to warn the driver of the vehicle of the upcoming precautionary zone. The infrared light is both inexpensive to produce and detect, as well as providing a clear and effective method of transmitting the proximity of the precautionary zone to the vehicle. Many existing systems utilized radio waves, which may cause or be susceptible to interference on congested airwaves.

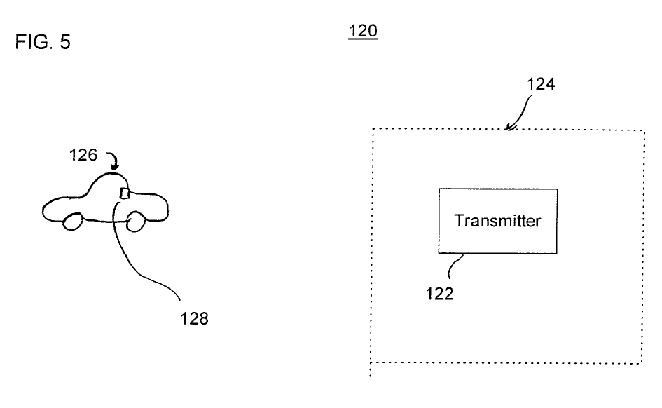

FIG. 5 is a simplified block diagram illustrating the components of a warning system 120 for warning a driver when exceeding a specified speed limit. The system includes a transmitter 122 located at or near a specified speed zone 124 and a vehicle 126 having a receiver 128.

The transmitter 122, preferably emits an infrared light beam. However, in other embodiments, the transmitter may transmit another light source, such as a laser beam. The receiver 128 is located on the vehicle 126 in such a fashion to detect any light source emanating from the transmitter 122. The receiver is a conventional light detecting receiver.

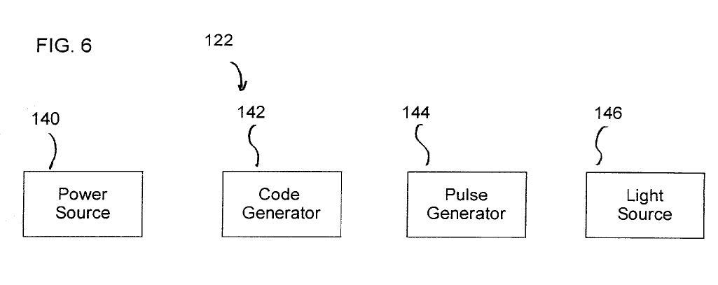

FIG. 6 is a block diagram illustrating the components of the transmitter 122 in an alternate embodiment of the present invention. The transmitter includes a power source 140, a code generator 142, a pulse generator 144, and a light emitting source 146.

In this alternate embodiment of the present invention, the code generator 142 generates a code associated with a particular speed allowable by vehicles transmitting the road where the transmitter is located.

The code generator provides the code to the pulse generator 144. The code is used by the pulse generator to create a pulsed light beam associated with the code. The pulse generator, in conjunction with the light emitting source 146, generates the coded light beam outwardly from the transmitter.

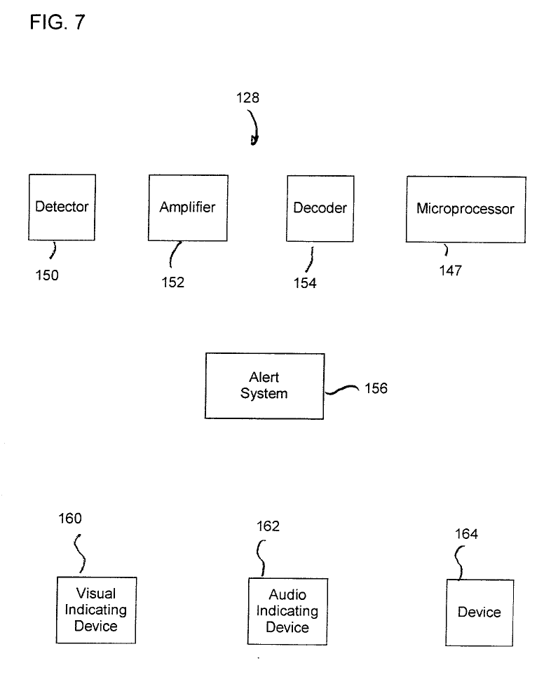

FIG. 7 is a block diagram illustrating the components of the receiver 128 in an alternate embodiment of the present invention. The receiver includes a detector 150 for detecting the light beam of light emanating from the transmitter 122. The detector includes a filter to prevent interference from stray light sources, such as sunlight or approaching headlights of oncoming vehicles. As discussed above, the preferred embodiment of the present invention utilizes an infrared transmitter, as well as an infrared detector.

The detected light signal received by the detector 150 is amplified by an amplifier 152. The amplified detected light signal is then fed to a decoder 154. The decoder interprets the pulse of the detected light and correlates the pulse with the specified code. The decoder then interprets the specified code with a specific speed. Next, the decoder feeds the specified speed limit to a microprocessor 147.

The microprocessor 147 determines the speed of the vehicle, preferably from data received from the speedometer. However, any device may be used to determine the speed of the vehicle. The microprocessor compares the determined speed of the vehicle and the speed limit received from the decoder 154 and determines if the vehicle is speeding. If the vehicle is speeding, the microprocessor sends a signal associated with the speed excess of the vehicle to an alert system 156.

The alert system 156 may include one or more warning indicators to drivers of the vehicles to which the receiver 128 is installed. The alert system may provide a signal to a visual indicating device 160, such as a digital indicator of the speed of the vehicle or a flashing light indicating that the vehicle is speeding. In addition, the alert system may include an audio indicating device 162, providing an aural warning to the driver. The aural warning may be a warning sound (e.g., buzz or chime) or series of specified sounds (e.g., different numbers or tone), or may include a verbal warning provided through a voice synthesizing device located within the alert system. In addition, the alert system may provide an electrical signal to some other type of device 164, such as a head up display (HUD) or an auxiliary safety system providing additional safety features for the vehicle, such as automatically reducing the speed of the vehicle.

With reference to FIGS. 5-7, the warning system 120 will now be explained. The driver of the vehicle 126 is driving along a road, unaware of the upcoming speed zone 124. For example, a reduced speed zone may be located ahead of the vehicle (e.g., a reduction of speed from 65 miles per hour to 35 miles per hour).

The transmitter 122 transmits a coded light indicating the speed limit of the zone associated with the transmitter to the vehicle 126. The receiver 128 located on the vehicle receives the coded light signal and amplifies the light signal. This detected light signal is amplified by the amplifier 152 and decoded by the decoder 154. The decoder interprets the light signal, indicating the speed limit of the zone for which the vehicle is transiting. The decoder sends a signal indicating the speed limit to the microprocessor 147. The microprocessor determines the actual speed of the vehicle from data received from the vehicle. The microprocessor then determines if the vehicle is speeding. If the vehicle is speeding, the microprocessor sends a signal to the alert system 156 indicating that the vehicle is speeding. The alert system then sends a signal to one or more indicating devices. The indicating devices may provide a visual or aural indication of the excess speed or the actual speed of the vehicle. Additionally, the alert system may send a signal to the device 164 for use with an auxiliary safety device. The driver receives the warning indication and acts appropriately (e.g., reduces speed of the vehicle).

The warning system 120 provides the advantage of specifically warning a vehicle if it is exceeding the speed limit. The warning is presented to the driver in such a fashion, that the driver cannot easily ignore. By warning the driver of the current speed, or the excessive speed of the vehicle, the driver can easily and quickly correct the speed violation, thereby increasing road safety.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for warning a driver of a vehicle of an upcoming precautionary zone, the system comprising:
a light emitter, said emitter being associated with the precautionary zone and emitting a coded light signal;
a receiver for detecting the coded light signal from said emitter, said receiver mounted on the vehicle; and
an alert system for indicating a warning to the driver when said receiver detects the coded light signal from said light emitter, whereby said warning provides an alert of a proximity of the precautionary zone to the driver.

2. The system for warning a driver of a vehicle of claim 1 wherein:
said light emitter emits an infrared light signal; and
said receiver detects the infrared light signal.

3. The system for warning a driver of a vehicle of claim 1 wherein:
said light emitter emits a laser signal; and
said receiver detects the laser signal.

4. The system for warning a driver of a vehicle of claim 1 wherein:
said coded light signal indicating a category of the precautionary zone;
said receiver receives the coded light signal and decodes the coded light signal, said receiver associating the decoded light signal with a category of the precautionary zone; and
said alert system provides an indication to the driver associated with the decoded category of the precautionary zone.

5. The system for warning a driver of a vehicle of claim 1 wherein:
said coded light signal indicating a specific speed associated with the precautionary zone;
said receiver receives the coded light signal and decodes the coded light signal, said receiver associating the decoded light signal with the specific speed associated with the precautionary zone; and
said alert system provides an indication to the driver associated with the decoded specific speed of the precautionary zone.

6. The system for warning a driver of a vehicle of claim 1 wherein said light emitter is located in the precautionary zone.

7. The system for warning a driver of a vehicle of claim 6 where said light emitter is stationary.

8. The system for warning a driver of a vehicle of claim 6 wherein said light emitter is affixed to a mobile precautionary zone.

9. The system for warning a driver of a vehicle of claim 1 wherein said light emitter is located near the precautionary zone.

10. The system for warning a driver of a vehicle of claim 1 wherein said alert system provides a visual indication alerting the driver of the proximity of the precautionary zone to the driver.

11. The system for warning a driver of a vehicle of claim 10 wherein said visual indication includes a visual symbology located on a display within the vehicle.

12. The system for warning a driver of a vehicle of claim 1 wherein said alert system provides an audio indication alerting the driver of the proximity of the precautionary zone to the driver.

13. The system for warning a driver of a vehicle of claim 1 wherein said alert system provides a signal to an auxiliary safety device located on the vehicle reacting to the proximity of the precautionary zone.

14. A method of warning a driver of a vehicle of an upcoming precautionary zone, said method comprising the steps of:
emitting, by a transmitter associated with the precautionary zone, a coded light signal;
detecting, by a receiver mounted to the vehicle, the coded light signal;
informing, by the receiver, the receipt of the coded light signal to an alert system; and
alerting, by the alert system, a warning of the proximity of the precautionary zone.

15. The method of warning a driver of a vehicle of claim 14 wherein:
said coded light signal being associated with a specific category of the precautionary zone;
the step of detecting the coded light signal includes the steps of:
detecting the coded light signal;
decoding the coded light signal; and
associating the coded light signal with the specific category of the precautionary zone; and
the step of informing the receipt of the coded light signal to the alert system included informing the alert system of the specific category of the precautionary zone.

16. The method of warning a driver of a vehicle of claim 14 wherein the step of emitting a coded light signal includes emitting an infrared light signal.

17. The method of warning a driver of a vehicle of claim 14 wherein the step of alerting, by the alert system, a warning of the proximity of the precautionary zone includes providing a visual indication to the driver.

18. The method of warning a driver of a vehicle of claim 14 wherein the step of alerting, by the alert system, a warning of the proximity of the precautionary zone includes providing an audio indication to the driver.

19. A system for warning a driver of a vehicle of an excessive speed associated with an upcoming precautionary zone, the system comprising:
a light emitter, said emitter being associated with the precautionary zone and emitting a coded light signal for indicating a speed zone associated with the precautionary zone;
a receiver for detecting and decoding the coded light signal from said emitter, said receiver mounted on the vehicle;
a microprocessor for receiving the decoded light signal from the receiver and determining if the vehicle is exceeding the speed limit, said microprocessor located on the vehicle; and
an alert system for providing an indication to the driver of the speed of the vehicle and an excess of the speed limit of the precautionary zone, said alert system receiving a notification from said microprocessor indicating an excess of speed of the vehicle.

20. The system for warning a driver of a vehicle of claim 19 wherein the coded light signal is an infrared coded light signal.
